(19) United States
(12) Patent Application Publication
(10) Pub. No.: US 2017/0241879 A1
(43) Pub. Date: Aug. 24, 2017

(54) TORSIONAL FATIGUE TESTING APPARATUS

(71) Applicant: HONOR GENE CO., LTD., New Taipei City (TW)

(72) Inventor: Chih Hsin CHOU, New Taipei City (TW)

(73) Assignee: HONOR GENE CO., LTD., New Taipei City (TW)

(21) Appl. No.: 15/130,470

(22) Filed: Apr. 15, 2016

(30) Foreign Application Priority Data
Feb. 22, 2016 (TW) 105202454

(51) Int. Cl. G01N 3/22

(52) U.S. Cl. CPC G01N 3/22

(57) ABSTRACT

A torsional fatigue testing apparatus comprises: a cable holding device, a motion guiding device and a driving device. The cable holding device is provided for holding a cable to be tested to extend between a rotatable holder and a slidable holder. The motion guiding device is provided for converting the rotational motion of the driving device into a reciprocating linear sliding motion by means of linkage so as to alternately rotate the rotatable holder forwardly and reversely, and therefore to repeatedly twist, by the rotatable holder, the cable to be tested.

### FIELD OF THE INVENTION

The present invention relates to a torsion testing machine, and more particularly relates to a torsional fatigue testing apparatus.

### BACKGROUND OF THE INVENTION

A fatigue test is a kind of structural test for components and members, used to study and verify the phenomenon of components and members in physical properties such as strength weakened, or having a crack or a break caused by bearing repeatedly applied loads during long-term use. Since the fatigue of components or members is a major factor in mechanical damage, it is rather necessary to determine the durability of components or members by fatigue tests to ensure machine reliability.

A torsional fatigue test is a type of fatigue test which tests the durability of an object to be tested (e.g., a cable) by repeatedly twisting it at a given angle, and the torsional fatigue test is usually performed using a torsion testing machine. A conventional torsion testing machine mainly includes a holder for holding the object to be tested and a servo motor for applying a twisting force to the object to be tested, wherein the object to be tested is twisted at a forward and reverse angle alternately by controlling the servo motor to rotate forward and backward alternately and regularly.

However, since the utilization of a servo motor to repeatedly twist an object to be tested involves many complicated motor operations such as a speed control during the switch between a forward rotation and a reverse rotation of a motor, and involves a maximum rotation angle control for a forward twisting and a reverse twisting, it is thus difficult to control the conventional torsion testing machine and to maintain the precision of test parameters. Besides, since an alternately forward and reverse rotation causes higher wear rate of the servo motor than a unidirectional rotation, a long duration of a fatigue test will significantly increase the replacement frequency of the servo motor, therefore leading to high maintenance cost.

### SUMMARY OF THE INVENTION

Accordingly, the conventional torsion testing machine has problem in the operational difficulties, the maintenance of the precision of the test and maintenance cost.

Consequently, one of the objects of the present invention is to provide a torsional fatigue testing apparatus having simplified operating procedure, providing high-precision fatigue test with low maintenance cost.

In order to overcome the technical problems in prior art, the present invention provides a torsional fatigue testing apparatus, comprising:

a cable holding device, including a rotatable holder and a slidable holder which are spaced apart from each other by a predetermined test distance on a torsion axis around which the rotatable holder is rotatable and along which the slidable holder is slidable, whereby performing a torsional fatigue test in which the rotatable holder is rotated to apply a torsion to a cable to be tested which is extended between the rotatable holder and the slidable holder is carried out;

a motion guiding device, having a linear slide member which is linearly slidable and is connected to a radius portion of the rotatable holder so as to rotate the rotatable holder when the linear slide member is performing a linear sliding motion; and

a driving device, including a driving member, a rotation member and a linkage member, wherein the rotation member is driven by the driving member in such a manner that the rotation member rotates in a predetermined rotation direction at a predetermined rotating speed, and the linkage member is provided with an end portion being pivotally connected to the rotation member at an off-center distance with respect to a center of the rotation member and the other end portion being connected to the linear slide member in such a manner that the linear slide member performs a reciprocating linear sliding motion when the rotation member is rotating.

According to one embodiment of the present invention, the torsion axis is substantially parallel to the direction of gravity.

According to one embodiment of the present invention, the slidable holder includes a fixed outer ring and a slidable inner ring, and the fixed outer ring has a through channel penetrating therethrough along the torsion axis, and the slidable inner ring is slidable in the through channel and has a receiving hole for receiving the cable to be tested.

According to one embodiment of the present invention, the torsional fatigue testing apparatus further comprises a conduction detecting device including a detecting unit connected in series with the cable to be tested to detect a fatigue failure within the cable to be tested.

According to one embodiment of the present invention, the torsional fatigue testing apparatus further comprises a weight object attached to the cable to be tested.

According to one embodiment of the present invention, the linear slide member is linearly slidable along a loop path.

According to one embodiment of the present invention, the linear slide member is a chain member.

According to one embodiment of the present invention, the linkage member has an adjustable length between the rotation member and the linear slide member.

According to one embodiment of the present invention, the off-center distance between the center of the rotation member and the end portion of the linkage member is adjustable.

According to one embodiment of the present invention, a plurality of the rotatable holders and a plurality of the slidable holders are provided in the cable holding device, and the plurality of the rotatable holders are connected to the linear slide member.

Via the technical means adopted by the present invention, the torsional fatigue testing apparatus according to the present invention can twist the cable to be tested at a forward and reverse angle alternately by continuous and unidirectional rotation without complicated motor speed control, thereby significantly decreasing the operational difficulties. Furthermore, the test parameters (e.g., twisting angle) of the torsional fatigue testing apparatus according to the present invention can be easily and precisely adjusted by changing the configuration of the devices and members of the torsional fatigue testing apparatus, thereby effectively avoiding inaccuracies due to an insufficient precision of the motor control. Besides, in the present invention, the motor requirements of the torsional fatigue testing apparatus is less demanding, i.e., motors used in the torsional fatigue testing is only required to perform rotation in one direction, and therefore few wear and tear of the machine occurs during the operation of the machine, and most commercially-available motors can be used in the torsional fatigue testing apparatus of the present invention, thereby significantly saving machine maintenance cost caused by part replacement and repair.

### BRIEF DESCRIPTION OF THE DRAWINGS

FIG. 1 is a stereogram illustrating a torsional fatigue testing apparatus according to one embodiment of the present invention;

FIG. 2a is a front view of the torsional fatigue testing apparatus according to the embodiment of the present invention;

FIG. 2b is a side view of the torsional fatigue testing apparatus according to the embodiment of the present invention;

FIG. 3 is a top view of the torsional fatigue testing apparatus according to the embodiment of the present invention; and

FIG. 4 is a cross-sectional view of the torsional fatigue testing apparatus according to the embodiment of the present invention.

### DETAILED DESCRIPTION OF THE PREFERRED EMBODIMENTS

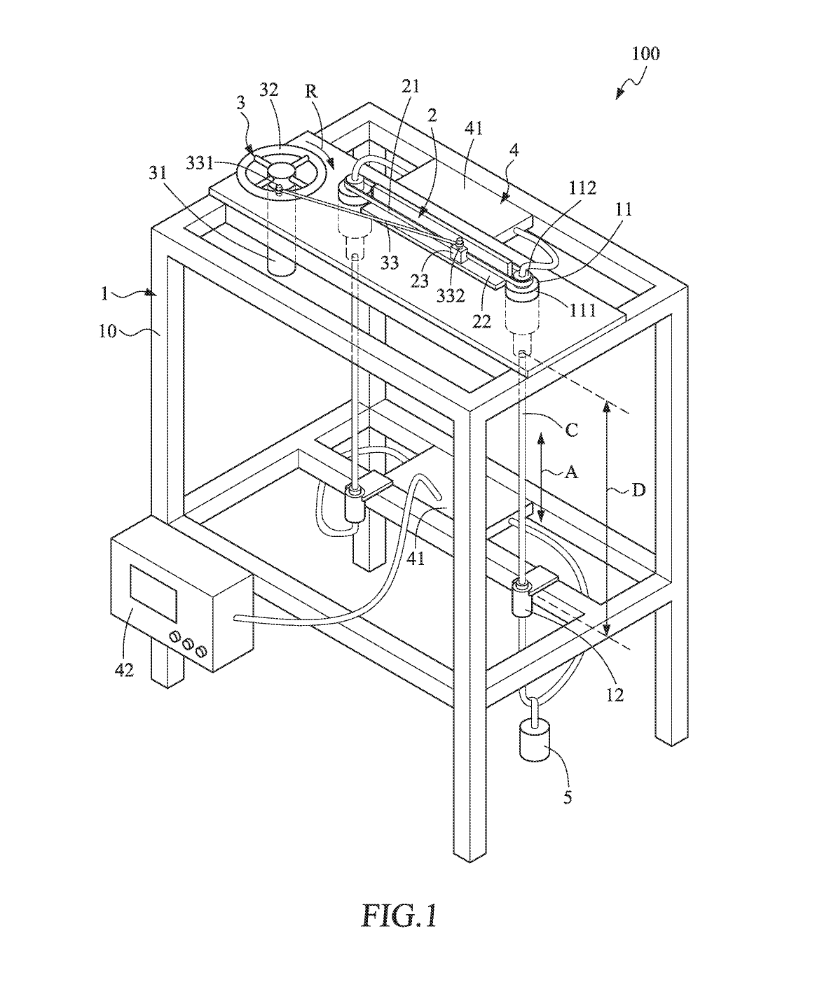

The preferred embodiments of the present invention are described in detail below with reference to FIG. 1 to FIG. 4. The description is used for explaining the embodiments of the present invention only, but not for limiting the scope of the claims.

As shown in FIG. 1 to FIG. 3, a torsional fatigue testing apparatus 100 according to one embodiment of the present invention comprises: a cable holding device 1, including a rotatable holder 11 and a slidable holder 12 which are spaced apart from each other by a predetermined test distance D on a torsion axis A around which the rotatable holder 11 is rotatable and along which the slidable holder 12 is slidable, whereby performing a torsional fatigue test in which the rotatable holder 11 is rotated to apply a torsion to a cable to be tested C which is extended between the rotatable holder 11 and the slidable holder 11 is carried out; a motion guiding device 2, having a linear slide member 21 which is linearly slidable and is connected to a radius portion of the rotatable holder 11 so as to rotate the rotatable holder 11 when the linear slide member 21 is performing a linear sliding motion; and a driving device 3, including a driving member 31, a rotation member 32 and a linkage member 33, wherein the rotation member 32 is driven by the driving member 31 in such a manner that the rotation member 32 rotates in a predetermined rotation direction R at a predetermined rotating speed, and the linkage member 33 is provided with an end portion 331 being pivotally connected to the rotation member 32 at an off-center distance with respect to a center of the rotation member 32 and the other end portion 332 being connected to the linear slide member 21 in such a manner that the linear slide member 21 performs a reciprocating linear sliding motion when the rotation member 32 is rotating.

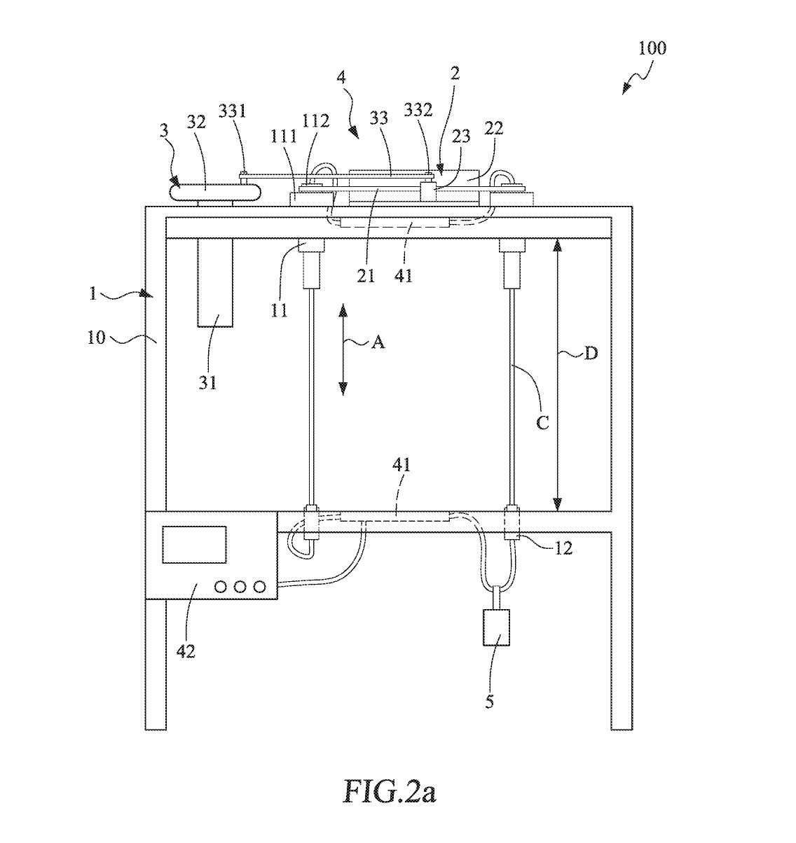

Specifically, an example of the cable holding device 1 is shown in FIG. 1, FIG. 2a and FIG. 2b, which includes a double-deck frame 10, wherein the rotatable holder 11 is disposed at an upper deck of the frame 10 and the slidable holder 12 is disposed at a lower deck of the frame 10 in such a manner that the rotatable holder 11 and the slidable holder 12 are spaced apart from each other. With the above-mentioned structure, in the present embodiment, a distance between the rotatable holder 11 and the slidable holder 12 can be adjusted by changing the height difference between the upper deck and the lower deck, thereby determining the test distance D of the cable to be tested C in the torsional fatigue test. Furthermore, such vertical arrangement between the rotatable holder 11 and the slidable holder 12 makes the torsion axis A substantially parallel to the direction of gravity, and therefore the influence of gravity on the cable to be tested C can be removed from the test. Besides, note that in the present application, the number of the rotatable holder 11 and the slidable holder 12 are not limited. The cable holding device 1 can be provided with a plurality of the rotatable holders and a plurality of the slidable holders, e.g., there are two rotatable holders and two slidable holders provided in the present embodiment, as long as the plurality of the rotatable holders are connected to the linear slide member 21 in a manner of being rotated by the linear slide member 21.

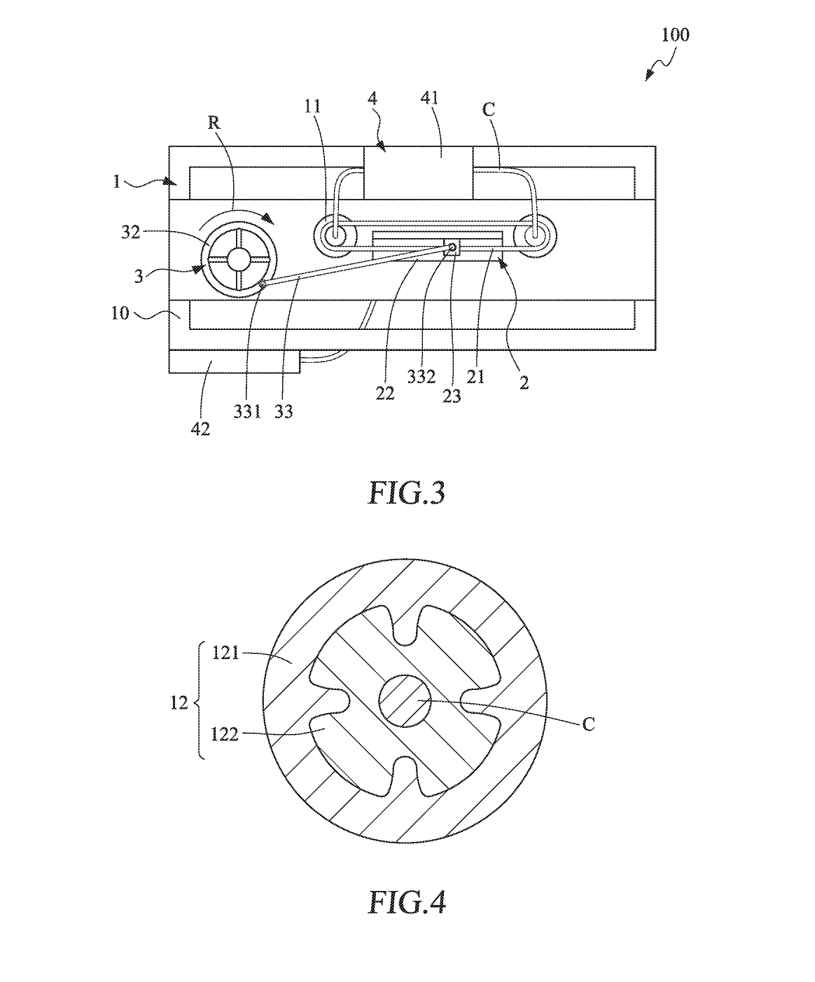

As shown in FIG. 1, FIG. 2a and FIG. 2b, the rotatable holder 11 in the embodiment includes a stator member 111 and a rotor member 112. The stator member 111 is fixed to the frame 10 and the rotor member is rotatably fit in the stator member 111. Moreover, the rotor member 112 is provided for securely receiving the cable to be tested C therein so that one end of the cable to be tested C can be driven to rotate by the rotation of the rotor member 112. As further shown in FIG. 4, the slidable holder 12 includes a fixed outer ring 121 and a slidable inner ring 122. The fixed outer ring 121 is fixed to the frame 10 and has a through channel penetrating therethrough along the torsion axis A, and the slidable inner ring 122 is slidable in the through channel so as to slide with respect to the fixed outer ring 121 along the torsion axis A. Furthermore, the through channel is non-circular in cross-section so as to restrain the slidable inner ring 122 from rotating around the torsion axis A. The slidable inner ring 122 has a receiving hole penetrating therethrough along the torsion axis A for receiving the cable to be tested C so that the other end of the cable to be tested C cannot be rotatable around the torsion axis A and can only be slidable along the torsion axis A.

The above mentioned structure of the rotatable holder 11 and the slidable holder 12 is provided for applying a torsion to the cable to be tested C extended between the rotatable holder 11 and the slidable holder 12 by utilizing the rotation of the rotatable holder 11 driving one end of the cable to be tested C to twist, and by utilizing the slidable holder 12 holding the other end of the cable to be tested C to restrain it from rotating. Furthermore, a small tensile strain generated on the cable to be tested C along the torsion axis A when the cable to be tested C is twisted can be eliminated by the sliding of the slidable holder 12, and therefore the influence of the unexpected tensile strain on the cable to be tested C, e.g., a premature breaking of the cable to be tested C, can be avoided.

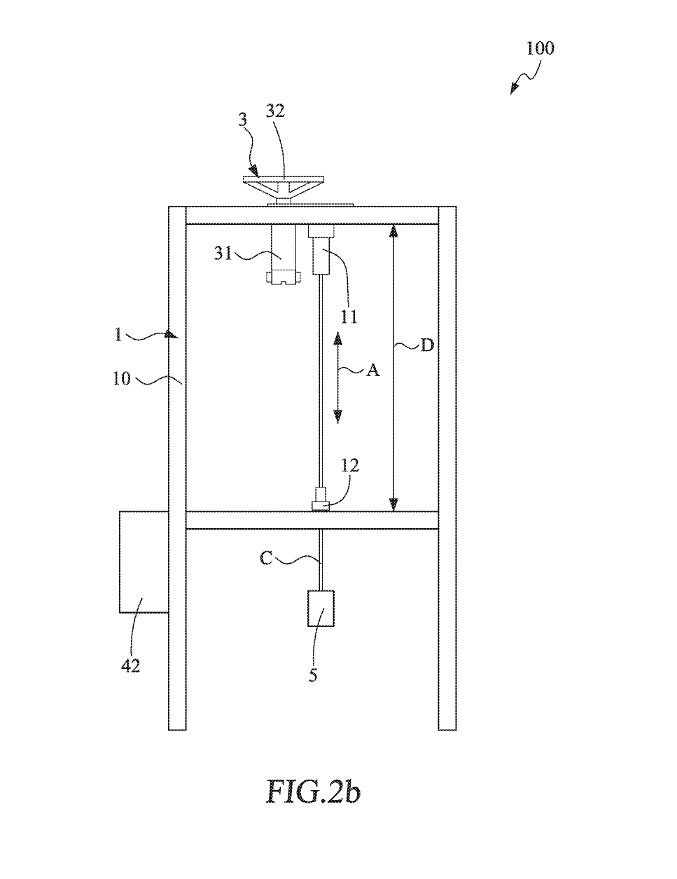

As shown in FIG. 1 and FIG. 3, in the present embodiment, the motion guiding device 2 includes a linear slide member 21, a rail 22 and a slider 23. The slider 23 is slidable on the rail 22 and is connected to the linear slide member 21 so as to guide the linear slide member 21 to perform a linear sliding motion along the rail 22. However, the sliding motion of the linear slide member 21 can include non-linear sliding motion and is not limited to the above-described. For example, the linear slide member 21 in the embodiment is linearly slidable along a circulation path. Besides, although the linear slide member 21 in the embodiment is a chain member encircling the rotor member 112 of the rotatable holder 11 so as to rotate the rotor member 112, the linear slide member 21 may be a rack, a belt or other members.

As shown in FIG. 1 and FIG. 3, the linkage member 33 of the driving device 3 is connected between an off-centered position of the rotation member 32 and the slider 23 of the motion guiding device 2 in such a manner that rotational motion of the rotation member 32 can be converted to a linear motion by means of the linkage member 33 and the slider 23 to make the linear slide member 21 perform a linear sliding motion, and therefore the rotor member 112 is rotated by the linear slide member 21. In detail, the rotational motion of the rotation member 32 can be divided into the first semicircular rotating from the left hand side to the right hand side of the FIG. 3, and the second semicircular rotating from the right hand side to the left hand side of the FIG. 3. The first semicircular rotating makes the linkage member 33 move toward right, thereby pushing the linear slide member 21 toward the right side to rotate the rotatable holder 11 counterclockwise. The second semicircular rotating makes the linkage member 33 back toward left, thereby pulling the linear slide member 21 toward left to rotate the rotatable holder 11 clockwise.

With the above mentioned structure, the linear slide member 21 performs a reciprocating linear sliding motion when the rotation member 32 is rotating, thereby the rotatable holder 11 rotating clockwise and counterclockwise alternately to twist the cable to be tested in a forward and reverse angle alternately. Furthermore, the test parameters such as the twisting angle of the rotation holder 11 can be adjusted by changing the radius position of the rotatable holder 11 at which the linear slide member 21 is connected, the relative distance and angle between the rotatable holder 11 and the rotation member 32 and so on without involving a control of the driving member 31. Therefore, it is preferred that the linkage member 33 is provided with a length adjustable between the rotation member 32 and the linear slide member 21, and/or provided with the off-center distance adjustable between the center of the rotation member 32 and the end portion of the linkage member 33 so as to adjust the test parameters quickly and easily by changing the configuration of the components. The specific structure can be the linkage member 33 being telescopic, or the connection point between the linkage member 33 and the rotation member 32 or the linear slide member 21 being adjustable.

As shown in FIG. 1 and FIG. 3, in the present embodiment, the torsional fatigue testing apparatus 100 further includes a conduction detecting device 4. The conduction detecting device 4 includes a detecting unit 41 and a monitor unit 42. The detecting unit 41 is connected in series with the cable to be tested C to detect a fatigue failure within the cable to be tested C according to a change of conductivity state of the cable to be tested C, e.g. from a conducting state to a non-conducting state, when the cable to be tested C has internal wire breaks. The monitor unit 42, which is electrically connected to the detecting unit 41, is used for displaying a detection result of the detecting unit 41 and for configuring the detecting unit 41.

As shown in FIG. 1, FIG. 2a and FIG. 2b, in the present embodiment, the torsional fatigue testing apparatus 100 further includes a weight object 5 attached to the cable to be tested C, used to test the torsional fatigue of the cable to be tested C under different conditions of loading.

The above description is only an explanation of the preferred embodiments of the present invention. A person with ordinary skill in the art can make various modifications without deviating from the present invention. However, those modifications shall still fall within the scope of the present invention.

What is claimed is:

1. A torsional fatigue testing apparatus, comprising:
a cable holding device, including a rotatable holder and a slidable holder which are spaced apart from each other by a predetermined test distance on a torsion axis around which the rotatable holder is rotatable and along which the slidable holder is slidable, whereby performing a torsional fatigue test in which the rotatable holder is rotated to apply a torsion to a cable to be tested which is extended between the rotatable holder and the slidable holder is carried out;
a motion guiding device, having a linear slide member which is linearly slidable and is connected to a radius portion of the rotatable holder so as to rotate the rotatable holder when the linear slide member is performing a linear sliding motion; and
a driving device, including a driving member, a rotation member and a linkage member, wherein the rotation member is driven by the driving member in such a manner that the rotation member rotates in a predetermined rotation direction at a predetermined rotating speed, and the linkage member is provided with an end portion being pivotally connected to the rotation member at an off-center distance with respect to a center of the rotation member and the other end portion being connected to the linear slide member in such a manner that the linear slide member performs a reciprocating linear sliding motion when the rotation member is rotating.

2. The torsional fatigue testing apparatus as claimed in claim 1, wherein the torsion axis is substantially parallel to the direction of gravity.

3. The torsional fatigue testing apparatus as claimed in claim 1, wherein the slidable holder includes a fixed outer ring and a slidable inner ring, and the fixed outer ring has a through channel penetrating therethrough along the torsion axis, and the slidable inner ring is slidable in the through channel and has a receiving hole for receiving the cable to be tested.

4. The torsional fatigue testing apparatus as claimed in claim 1, further comprising a conduction detecting device including a detecting unit connected in series with the cable to be tested to detect a fatigue failure within the cable to be tested.

5. The torsional fatigue testing apparatus as claimed in claim 1, further comprising a weight object attached to the cable to be tested.

6. The torsional fatigue testing apparatus as claimed in claim 1, wherein the linear slide member is linearly slidable along a loop path.

7. The torsional fatigue testing apparatus as claimed in claim 1, wherein the linear slide member is a chain member.

8. The torsional fatigue testing apparatus as claimed in claim 1, wherein the linkage member has an adjustable length between the rotation member and the linear slide member.

9. The torsional fatigue testing apparatus as claimed in claim 1, wherein the off-center distance between the center of the rotation member and the end portion of the linkage member is adjustable.

10. The torsional fatigue testing apparatus as claimed in claim 1, wherein a plurality of the rotatable holders and a plurality of the slidable holders are provided in the cable holding device, and the plurality of the rotatable holders are connected to the linear slide member.
